(19) United States
(12) Patent Application Publication
(10) Pub. No.: US 2011/0295429 A1
(43) Pub. Date: Dec. 1, 2011

(54) Method for Controlling a Processing Machine with Driven Axes

(75) Inventors: Stephan Schultze, Lohr-Wombach (DE); Christian Zentgraf, Schoellkrippen (DE); Michael Seubert, Retzstadt (DE)

(73) Assignee: Robert Bosch GmbH, Stuttgart (DE)

(21) Appl. No.: 13/125,808

(22) PCT Filed: Sep. 1, 2009
(86) PCT No.: PCT/EP09/06309

§ 371 Date: Aug. 12, 2011

(30) Foreign Application Priority Data
Oct. 25, 2008 (DE) 10 2008053.249.5

(51) Int. Cl. G05B 15/02

(52) U.S. Cl. 700/275

(57) ABSTRACT

A method for controlling a processing machine with driven axes, in particular a printing press, wherein a radius of at least one axis is used to automatically determine a control limiting value.

The present invention relates to a method for controlling a processing machine with driven axes, in particular a printing press, an appropriately equipped computing unit, a corresponding computer program and a corresponding computer program product.

Although, in the following text, reference is primarily made to printing presses, the invention is not restricted thereto but instead is directed to all types of processing machines with driven axes, at least one axis with a variable diameter or replaceable axes with different diameters being provided. However, the invention can also be used in particular in printing presses, such as newspaper presses, jobbing presses, gravure presses, packaging presses or valuable-document presses and also in processing machines such as bag making machines, envelope making machines, packaging machines, material processing machines, paper production machines, film stretching machines, rewinders and the like. The machine can be set up to process paper, material, paperboard, plastic, metal, rubber, films and so on.

In the following text, “axis” should be understood to mean a shaft, drum, reel, roll or roller rotating about a longitudinal axis, in particular one that is replaceable and/or of variable diameter.

### PRIOR ART

In relevant processing machines, in particular printing presses, a product web is kept ready on an unwind roll. The product web is then moved along driven axes (web transport axes or web transport devices), such as pull rolls or feed rolls, and non-driven axes, such as deflection, guide, drying or cooling rolls. The product web is simultaneously processed by means of usually likewise driven processing axes, for example printed, punched, cut, folded and so on. Once the product web has passed through the processing machine, it is generally wound up on a winder roll or processed further in another way.

In printing presses, processing axes also formed as sleeve axes are known, in which a sleeve, as an image-bearing element, is pushed over a cylinder.

Stipulations existing in the prior art make it necessary to restrict the maximum rotational speed of said axes in order not to exceed a rotational speed limiting value. Here, these can be material-specific limiting values in order, for example, not to exceed a maximum permissible transport speed of a material during the processing. If the surface speed of the roll becomes too high during operation, this can possibly have detrimental effects on the product web or the processing thereof. Likewise, there can be machine guidelines or safety regulations which stipulate a maximum surface speed of cylinders. It is therefore usual in the prior art to stipulate a fixed rotational speed limiting value for each axis. During safety-related movement processes, the limiting values, for example in a drive, are monitored for safety. In this case, according to the prior art, what are known as the “safe reduced speed” and the “safe maximum speed”, for example, count as a monitoring function in relation to machine safety. In the case of reliable monitoring, a variable to be monitored is monitored by at least two independent systems (including users), the measured values from which are compared. Reliable monitoring is usually implemented with two channels.

Similar stipulations exist in relation to monitoring accelerating and braking operations. Here, too, there exist fixedly stipulated rotational speed change limiting values, which must not be exceeded during acceleration operations and must not be undershot during retardation operations, in particular stopping operations, so that slow accelerations and rapid stopping can be achieved. The rotational speed change limiting values normally depend on the moment of inertia of the respective cylinder. The inertia of a corresponding axis can also become a hazard for the operating personnel when aligning the axis or setting up the roll if the latter has to be moved, possibly with the aid of the center drive. In the prior art, for example, changeover work in the case of winders may be carried out only with no torque or at a safe maximum rotational speed, based on the maximum moment of inertia to be expected. This means that the rotation of the roll must be carried out by hand, which is frequently not possible in the case of large winders because of the mass and inertia of the winder, or that the safe maximum rotational speed is a very low rotational speed.

It has been shown that the limiting values, once stipulated, do not always ensure optimum operation in all processing machines. In particular, it is possible for changes in the machine configuration to occur, so that the existing safety limiting values are no longer determined optimally.

However, changing the limiting values is complicated and is thus avoided in most cases, for which reason, in the prior art, the limiting values are usually designed for the least favorable case occurring during the processing.

The reliability monitoring systems of center winders corresponding to the prior art operate, for example, with a fixed maximum rotational speed. Braking and accelerating ramp control systems and the monitoring equipment thereof are designed here for the maximum occurring moment of inertia. In the case of processing axes, according to the prior art only fixed rotational speeds are monitored during reliability monitoring.

There is therefore a need for improved methods for controlling corresponding processing machines with driven axes.

Against this background, with the present invention a method for controlling a processing machine with corresponding driven axes, in particular a printing press, a computer program and a computer program product having the features of the independent patent claims are proposed. Advantageous developments are the subject matter of the subclaims and of the following description.

### ADVANTAGES OF THE INVENTION

Safe movements, i.e. in particular rotational speeds, rates of acceleration and/or braking, according to the prior art are always oriented toward the maximum occurring surface speed/acceleration or toward the maximum occurring torque. Thus, in the prior art, the basis used for determining the limiting values is the largest occurring diameter of the respective cylinder.

In particular in the case of winders having very sharply varying diameters or replaceable axes with different diameters, this results in a very low surface speed in the case of a small circumference, which means that the processing and changeover operations are slowed unnecessarily. If movements associated with a risk or disadvantageous movements are derived from surface speeds, in principle any limitation to a fixed, non-changeable rotational speed is not optimal. In the case of an assumed, fixed speed (rotational speed) of the center drive, different surface speeds are obtained, depending on the diameter.

In gravure printing presses or packaging presses as well, the diameter of the processing axes (impression cylinders)—as in the case of sleeve axes—likewise depends on production. Since the circumference of the impression cylinder coincides with the format length of the printing format and the intention is to be able to process various formats on one machine, the surface speeds in gravure printing cylinders are also different, depending on the impression cylinder diameter, with a constant rotational speed of the motor drive.

While, in the case of a winder axis, the diameter changes during the process because of winding or unwinding, the diameter in the case of the aforementioned replaceable axes is certainly constant during the individual process, but is different as a function of the production (as a function of the job).

In the method according to the invention for controlling a processing machine with driven axes, in particular a printing press, a current radius of the axis is determined and, on this basis, improved control and/or monitoring are/is made possible. In particular, it is possible to automatically adapt the limiting values optimally to the instantaneous machine configuration and, as a result, to accelerate the processing or changeover operations without reducing the safety of the user. Manual actions by the operator, which are time-consuming and subject to errors, can be avoided. As a result of the automated consideration of the instantaneous radius, optimal control which is designed for the actual current variables can always be carried out.

According to the invention, and therefore, as opposed to the conventional constant rotational speed control or rate control, the radius, and therefore the surface speed and the torque of the moving axis, is automatically considered for the first time. In this way, the processing speed can be increased whilst maintaining the desired user and machine safety.

The invention is particularly suitable if the radius of the at least one axis is a radius that varies during the processing. This is so, for example, in the case of winder axes which are thus always driven in accordance with their instantaneous diameter (mass) during the processing.

It is preferable to monitor the radius of the at least one axis reliably. As was already explained further above, “reliable monitoring” is to be understood to mean monitoring with at least two channels. If the respectively current value of the radius can be supplied reliably to the control system, the radius can also be taken into account for safe processes and also bring about the aforementioned advantages there. Reliable monitoring can, for example, be carried out without any user input via a two-channel measurement of the radius and a comparison of the measured results. In addition, a single-channel diameter measurement and a single-channel transfer from a higher-order control system with subsequent comparison of the values can be carried out. The aforementioned measurements can be carried out by means of an infeed, distance sensor or light barrier during a lateral movement operation. An infeed can be implemented, for example, laterally on the impression cylinder or another stop, it being possible for the mechanical contact to be detected from monitoring the drive torque or the like. By using the movement travel or the lateral position when making contact, the diameter can be determined.

According to a particularly preferred embodiment of the present invention, a rotational speed limiting value and/or a rotational speed change limiting value of at least one axis is determined automatically by considering the radius thereof. In this way, it is particularly advantageously possible to use the current diameter and the associated parameters for the calculation of the aforementioned actuating variables. In this way, it is possible to provide an optimal surface speed of the axis to be driven. A rotational speed limiting value comprises in particular a safe or non-safe maximum rotational speed which should not be reached or exceeded. In a corresponding way, a rotational speed change limiting value comprises in particular a safe or non-safe maximum acceleration which is not to be reached or exceeded during accelerating operations, and/or a safe or non-safe minimal acceleration which is not to be undershot during braking operations. In this way, during stopping operations, the time until the axis is at a standstill is intended to be monitored, preferably reliably.

In a particularly advantageous method, the rotational speed limiting value of at least one axis is determined as a ratio between a surface speed limiting value and the radius of said axis. This permits particularly simple and rapid provision of the maximum rotational speed and of the rotational speed limiting value for further method steps. Likewise, an acceleration limiting value or a rotational speed change limiting value of at least one axis can be determined from the ratio between a surface acceleration limiting value and the radius of said axis.

According to a particularly preferred embodiment, furthermore a moment of inertia of the at least one axis is determined by considering the radius. Determining the moment of inertia is advantageous in particular when manual alignment or changeover work is to be carried out on the axis, since it is possible for the inertia to prevent manual adjustment of the axis on account of the high mass thereof. In this way, within the context of such changeover work, rotation of an axis by a central drive can be effected with safe values in a particularly safe way.

Advantageously, the rotational speed change limiting value of the at least one axis is determined by incorporating the moment of inertia thereof. In this way, it is possible firstly that the axis is not accelerated excessively, which could lead to overloading of the drive or excessively fast rotation of the axis, secondly the axis is prevented from being accelerated or braked with an acceleration value that is lower than the optimum, which in turn would result in unnecessary losses of time.

Advantageously, the rotational speed change limiting value or the moment of inertia can be used in an acceleration and/or braking ramp control system, by means of which an appropriate rotational speed can be increased and/or reduced continuously or step by step. Advantageously, the acceleration and/or braking ramp control system can also be part of further control devices to be provided, but provision can also be made to provide the appropriate control system separately from the other devices.

The method can be employed in a particularly advantageous way in a printing press, in which the at least one axis is a winding or processing axis. In particular, here it can be an axis with a variable diameter or a replaceable axis, the replaceable axes used having different diameters. Furthermore, provision can also be made of an axis in which an axis core can be provided with replaceable axis shells or sleeves, so that an axis having different diameters can be provided by using different axis shells (sleeve axes). As already explained previously, however, the invention is not restricted to printing presses but can be used in all devices which have axes with a correspondingly variable diameter, and which can profit in a particularly advantageous way from a control method according to the invention.

According to a particularly advantageous embodiment of the present invention, the radius of the at least one axis can be determined, in particular redundantly, by using a rotational speed, a machine speed, a measurement of the radius (direct measurement) and/or a user input. This determination can be carried out in various ways in order, in particular, to satisfy safety requirements which are placed on the corresponding device.

The radius can be determined by using a reliably determined rotational speed and a reliably determined machine speed. In winders having a tensioned winding material and in the case of processing axes connected to the product web by a force fit or form fit, a radius can be calculated by using the actual rotational speed of the roll and/or the processing axis and the machine speed. The rotational speed ratio of machine speed to roll or processing axis speed is in this case proportional to the radius. If the machine speed and the roll rotational speed or the rotational speed of the processing axis are present in the safety control system as a reliably determined value, then a maximum rotational speed can be calculated reliably in the safety control system.

The radius can also be determined via a single-channel, non-reliable measurement and a redundant evaluation of the machine speed and axis rotational speed. If the aforementioned calculation of the radius is carried out by using non-reliably determined values of machine speed and roll axis/processing axis rotational speed, an additional, single-channel, non-reliable measurement of the radius with a data comparison of the two radii determined can advantageously result in a reliably determined radius (plausibilization).

If a radius is measured with a sensor which provides a reliable value of the radius at its output, which is then transmitted to the safety control system, for example via a secure communications medium, then a reliable radius is also present in the safety control system here or one such radius can be provided. This is equivalent to a two-channel, reliable measurement of the radius. Furthermore, in the case of processing axes the diameters of which change only as a function of the job, i.e. not continuously, the radius/diameter of a processing axis can be entered reliably as a function of the job by the operator. In this case, a measurement is no longer made during the process or is made only for the purpose of monitoring. As an alternative to calculating the maximum rotational speed to be monitored, the latter can also possibly be input directly as a function of the job. Here, too, a reliable input is required.

Provision can advantageously be made to carry out the method continuously, cyclically and/or only when required, which means that the best possible control can be effected with the minimum technical effort.

The invention additionally relates to a computer program having program code means, in order to carry out all the steps of a method according to the invention when the computer program is executed on a computer or a corresponding computing unit, in particular in a processing machine.

The computer program product provided in accordance with the invention, having program code means which are stored on a computer-readable data storage medium, is designed to carry out all the steps of a method according to the invention when the computer program is executed on a computer or a corresponding computing unit, in particular in a processing machine. Suitable data storage media are in particular floppy disks, hard disks, flash memories, EEPROMs, CD-ROMs, DVDs and the like. A download of a program via computer networks (Internet, Intranet and so on) is also possible.

Further advantages and refinements of the invention can be gathered from the description and the appended drawing.

It goes without saying that the features mentioned above and those still to be explained below can be used not only in the respectively specified combination, but also in other combinations or on their own without departing from the scope of the present invention.

The invention is illustrated schematically in the drawing by using an exemplary embodiment and will be described extensively in the following text with reference to the drawing.

### DESCRIPTION OF THE FIGURES

FIG. 1 shows a schematic illustration of a processing machine designed as a printing press, which machine is suitable for the method according to the invention, according to a particularly preferred embodiment; and

FIG. 2 shows a schematic illustration of a method proceeding in accordance with a particularly preferred embodiment of the invention.

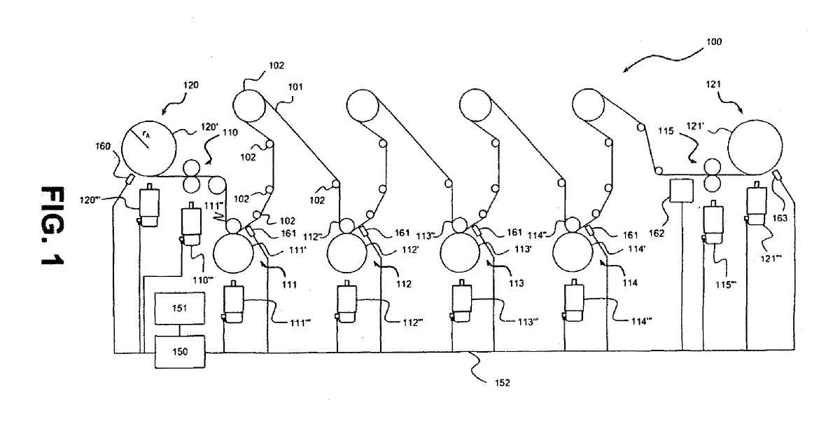

In FIG. 1, a processing machine configured as a printing press is designated overall by 100. A printing material, for example paper 101, is kept ready on an unwind 120 having an unwind roll or a reel 120′ and is fed to the machine via an infeed 110. The paper 101 is guided through processing devices constructed as printing units 111, 112, 113, 114, printed and output again by an outfeed 115. The paper 101 is then wound up on a rewinder 121. The unwind and the rewinder 120, 121 each have corresponding axes (rolls) 120′, 121′. It goes without saying that the printing press can also be designed without the rewinder and/or unwind 120, 121 and the paper 101 can be led in and out in another way. The infeed, outfeed and printing units can be arranged such that they can be positioned, in particular such that cylinders and angles can be corrected.

The printing units 111 to 114 each have an impression cylinder 111′ to 114′, which can be implemented as an impression cylinder having a corresponding variable circumference or diameter in order to adapt to the format to be printed, and against which in each case a pressure roll 111″ to 114″ can be set with high pressure. The impression cylinders can be driven individually and independently. The associated drives 111′″ to 114′″ are illustrated schematically. The infeed and the outfeed likewise have corresponding drives 110′″, 115′″. The pressure rolls are designed to be freely rotatable. The printing units 111 to 114, in each case together with the paper 101 running through, form a frictionally connected unit (clamping point). Unwind and rewinder 120, 121 likewise have drives 120′″, 121′″, which are preferably constructed as center drives and drive the unwind roll and rewinder roll 120′ and 121′, respectively. The drives of the unwind and of the rewinder 120′″, 121′″ and the drives of the individual units are connected via a data link 152 to a control system 150.

Furthermore, the printing press has sensors 160, 161, 162, 163 for acquiring characteristic machine variables, which are likewise connected to the control system 150. The characteristic machine variables preferably include, for example, the circumference, diameter, radius and/or the speed of the respectively associated axis, the speed of the paper web 101, or other speeds. The control unit 150 comprises in particular a configuration of a computing unit according to the invention and is set up for appropriate control. The control unit 150 is also connected to user input unit 151.

In the web sections between the individual printing units 111 to 114, the paper 101 is led over rollers, not specifically explained, which are designated by 102. For reasons of clarity, not all the rollers are provided with designations 102. These can in particular be deflection rollers, drying, cooling and/or trimming devices and so on.

The printing press is fed with the paper web 101 from the unwind roll 120′ by the unwind 120. The unwind roll 120′ is driven by the unwind drive 120′″. The sensor 160 monitors the radius and/or the speed of the unwind roll 120′. In a way analogous to this, the rewinder 121 with the rewinder roll 121′ and the rewinder drive 121′″ and also the sensor 163 are arranged in the outlet region of the printing press. Furthermore, a further sensor 162, which can in particular be a paper web speed sensor, is illustrated in the rewinding region of the rewinder 121. As explained previously, a calculation of the radius of a roll 120′, 111′, 112′, 113′, 114′, 121′ can be carried out in particular via a determination of machine speed and/or a direct determination of the radius.

During the operation, in which an uninterrupted paper web 101 is used, the radius r_{A} of the unwind roll 120′ decreases as a result of the unwinding, and the radius of the rewinder roll 121′ increases. In particular at fixed time intervals, possibly also continuously or at the start/end of the processing operation, sensors 160, 161, 162, 163 transmit radius and/or speed data to the control unit 150 via a preferably secure data link 152, for example via a secure field bus system or via binary inputs. In the event of job-dependent radius changes, that is to say if the radius does not change continuously, as may be the case in particular in the case of the processing rolls 111′, 112′, 113′, 114′, a radius can also be made available via the user input unit 151 of the control unit 150 (for example in the form of a user input). However, it is also possible for a sensor 161 to be provided for this purpose, which can be fitted beside the roll 114′ but also beside the further processing rolls. By this means, a radius of a processing roll can be determined, in particular once and as a function of the job. A method according to the invention proceeds in the control unit 150. In particular, radius-dependent control for the speed and/or the acceleration of a roll to be controlled is calculated here and, via the communications channel 152, is provided in particular for the drives 111′″, 112′″, 113′″, 114′″ and/or roll drives 120′″, 121′″.

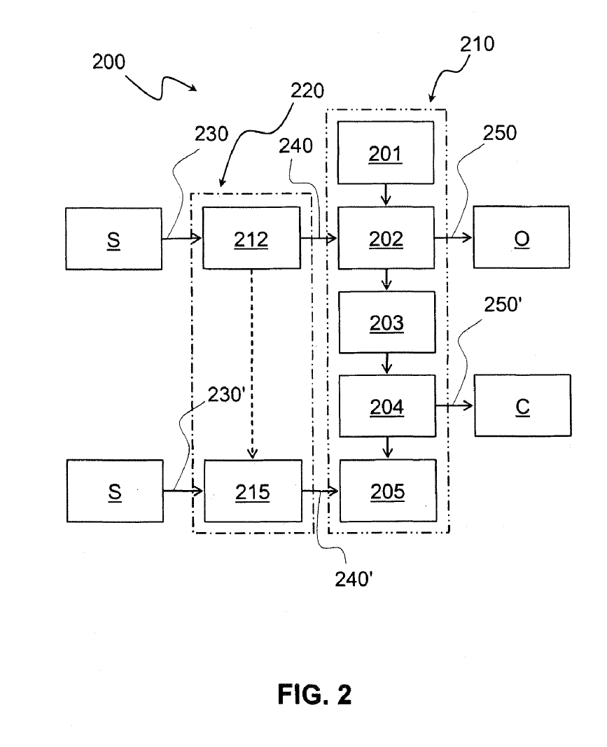

In FIG. 2, a flow chart of a method according to a particularly preferred embodiment of the invention is illustrated and designated overall by 200.

Provision can be made to execute the method in a central unit 210, which is connected to a sensor evaluation unit 220. However, this configuration is illustrated only by way of example. It goes without saying that different steps can be combined as desired into units.

In sequence step 201, a device, for example a printing press, is running in the basic state, that is to say rollers, rolls and/or axes to be controlled and/or to be monitored are being driven at constant speed and/or accelerated with a constant acceleration rate.

In step 202, an input is then made via an input channel 240. The input preferably originates from the sensor evaluation unit 220, which evaluates a sensor signal received from sensor S via a sensor channel 230 and provides said signal for the central unit 210 via the input channel 240. A user input can in particular also be provided via the input channel 240. In the present case, one input channel 240 is illustrated by way of example. However, it goes without saying that a plurality of input channels can also be provided, which provide processed or non-processed data, in particular sensor and/or user input data.

Provision can be made, via an output channel 250, to provide an output with regard to the received signal on an output O which, for example, can represent a visual display, by which means, for example, a user of the device is informed about a received sensor signal. An output O can also have signals applied to it via the output channel 250 at times other than the method step 202 illustrated here, which signals inform the user about the values respectively being used in the method, the values provided and/or the calculated values.

In the further sequence, in step 203, an associated radius is calculated from the signal received in the preceding step 202. As explained above, the calculation can originate from machine, roll or web speeds, which have been determined via a sensor S, or from a direct measurement of a radius by the sensor S. In particular, provision can also be made to carry out the calculation redundantly and with the incorporation of plausibility criteria which, if appropriate, are provided previously or simultaneously via further input channels (not illustrated) corresponding to input channel 240, or are present internally in the system.

In step 204, the central unit, which in particular can also be implemented in the form of computer equipment in accordance with a particularly preferred embodiment of the connection, makes an output to a control system C via the output or control channel 250′. The control system C in turn automatically effects control of a roll, roller and/or axis speed or acceleration in accordance with the signal, in particular on the basis of the calculated radius or the further characteristic variables provided in accordance with the invention.

In the further sequence, step 205 can be provided, in which the method remains in the current state until the receipt of a further signal via an input channel 240′, to which, in step 215, for example a signal value is applied to the sensor evaluation unit 220. This value can in particular consist in a new item of sensor information, which is dealt with on the basis of a signal received from sensor S via a sensor line 230′. Furthermore, in step 205, the determination of a steady state can also be made on the basis of identical or appropriately smoothed sensor signals. In this step, a comparison of the two radii determined can also be carried out. In the event of plausibility errors, an error reaction is then initiated.

It goes without saying that, in addition to the indicated input via the input channel 240 or 240′, in particular an input can also be provided via a possible user input, by means of which the method is carried out in accordance with steps 201 to 205.

Furthermore, provision can also be made to combine any desired number of the method steps illustrated into one method step, without departing from the invention.

It also goes without saying that only exemplary embodiments of the invention are illustrated in the figures shown. In addition, any other embodiment is conceivable without departing from the scope of this invention.

### LIST OF DESIGNATIONS

100 Printing press
101 Paper web
110 Infeed
111-114 Printing unit
111′-114′ Impression cylinder
111″-114″ Pressure roll
110′″-115′″ Drive
115 Outfeed
120 Unwind
120′ Unwind roll
120′″ Unwind drive
121 Rewinder
121′ Rewinder roll
121′″ Rewinder drive
150 Control system
151 User input
152 Data link
160-163 Sensors
200 Flow chart
201 Basic state
202 Data acquisition
203 Data evaluation
204 Activation
205 Maintenance
210 Central unit
212, 215 Sensor evaluation
220 Sensor evaluation unit
230, 230′ Sensor channel
240, 240′ Input channel
250, 250′ Output channel
S Sensor
O Output
C Control system
r_{A} Axis radius

1. A method for controlling a processing machine with driven axes, wherein a radius of at least one axis is used to automatically determine a control limiting value.

2. The method as claimed in claim 1, wherein the radius of the at least one axis is a radius that varies during the processing.

3. The method as claimed in claim 1, wherein the radius of the at least one axis is monitored reliably.

4. The method as claimed in claim 1, wherein the control limiting value determined is a rotational speed limiting value and/or a rotational speed change limiting value of the least one axis.

5. The method as claimed in claim 4, wherein the rotational speed limiting value of the at least one axis is determined as a ratio between a surface speed limiting value and the radius of said axis.

6. The method as claimed in claim 4, wherein the rotational speed change limiting value of the at least one axis is determined as a ratio between a surface acceleration limiting value and the radius of said axis.

7. The method as claimed in claim 4, wherein the rotational speed change limiting value is used in an acceleration and/or braking ramp control system.

8. The method as claimed in claim 1, wherein a moment of inertia of the at least one axis is determined by considering the radius thereof.

9. The method as claimed in claim 8, wherein the rotational speed change limiting value of the at least one axis is determined by considering the moment of inertia thereof.

10. The method as claimed in claim 1, wherein the at least one axis is a winding axis or a processing axis.

11. The method as claimed in claim 1, wherein the radius of the at least one axis is determined by considering a rotational speed, a machine speed, a measurement of the radius and/or a user input.

12. The method as claimed in claim 1, which is carried out continuously, cyclically and/or when required.

13. The method as claimed in claim 1, wherein the method is used for the safety-related monitoring of processes.

14. The method as claimed in claim 1, wherein the method uses a computer program having program code means, in order to carry out all the steps of the method for controlling the processing machine, when the computer program is executed on a computer or a corresponding computing unit.

15. The method as claimed in claim 1, wherein the method uses a A computer program product having program code means which are stored on a computer-readable data storage medium, in order to carry out all the steps of the method for controlling the processing machine, when the computer program is executed on a computer or a corresponding computing unit.

16. The method of claim 1, wherein the processing machine includes a printing press.
